(19) United States
(12) Patent Application Publication
(10) Pub. No.: US 2008/0135464 A1
(43) Pub. Date: Jun. 12, 2008

(54) Separating system for separating articles

(76) Inventor: Vadim A. Lubezny, Buffalo Grove, IL (US)

Correspondence Address: BRINKS HOFER GILSON & LIONE, P.O. BOX 10395, CHICAGO, IL, 60610, US

(21) Appl. No.: 11/974,678

(22) Filed: Oct. 15, 2007

Related U.S. Application Data
(60) Provisional application No. 60/852,370, filed on Oct. 17, 2006.

(51) Int. Cl. B07C 5/07

(52) U.S. Cl. 209/655; 209/662

(57) ABSTRACT

A separating system includes a chute and at least one rotatable roller disposed adjacent an end of a chute such that articles traversing the chute in the longitudinal direction impact the roller and are displaced to one or the other side of the roller. Various methods of separating articles are also provided.

This application claims the benefit of U.S. Provisional Application Ser. No. 60/852,370, filed Oct. 17, 2006, the entire disclosure of which is hereby incorporated herein by reference.

### FIELD OF THE INVENTION

The present invention relates generally to a separating system, and in particular, to a separating system for use in an infeed device.

### BACKGROUND

Separating systems typically are designed to separate articles for subsequent processing, including for example food processing. Separating systems can be used to distribute food articles, such as poultry parts, which are deposited into a hopper. The articles are typically transported from the hopper onto a chute via a conveyor. Upon entering the chute, the articles traverse a fall trajectory and are disposed onto a receptacle. Separating systems are generally used to displace large quantities of articles onto a receptacle, such as a conveyor, where they are separated for efficient sorting, weighing, and packaging. For example, some systems use a plurality of separators to define a plurality of channels at the bottom of the chute. Sometimes the articles, such as raw poultry parts, get hung up on the separators at the bottom of the chute. This can clog or slow down the system, and can lead to various inefficiencies.

### SUMMARY

The present invention is defined by the following claims, and nothing in this section should be considered to be a limitation on those claims.

In one embodiment, the separating system includes a chute comprising first and second longitudinally spaced ends. At least one roller having a first and second longitudinally spaced ends is positioned at one end of the chute. One end of the roller is positioned adjacent to the second end of the chute. The roller is rotatable about an axis. The separating system further includes at least one receptacle having at least a portion thereof disposed on at least one side of the roller.

In one preferred embodiment, the receptacle is configured as a conveyor having first and second ends. One end of the conveyor is positioned adjacent to the second end of the chute. The chute includes at least one divider having a first and second longitudinally spaced ends, where the second end of the divider is positioned adjacent to the first end of the roller. The conveyor includes at least one separator having a first and second longitudinally spaced ends. In one embodiment, the first end of the separator is positioned adjacent to the second end of the divider. In various embodiments, there may be a plurality of separators, dividers, and rollers.

In another aspect, a method for separating articles includes the steps of moving articles along a chute having longitudinally spaced first and second ends. The articles may be moved in a direction having a horizontal and/or vertical component. The method further includes impacting a roller positioned adjacent to the second end of the chute with at least one of the articles. The rotation of the roller displaces the articles to one side of the roller.

In one embodiment, the method includes altering a slope of the chute to change the rate of descent. The method further includes depositing the article onto the conveyor with the roller and transporting the article to a second receptacle, such as an accumulator or scale. Such an article may be a food product, such as poultry parts.

The various embodiments provide significant advantages over other separating systems, including for example and without limitation, poultry infeed devices. In particular, the rollers freely rotate to deposit the article onto the adjacent conveyor, which avoids the article from getting hung up on the separator and thereby clogging the system or requiring human intervention to displace the article.

The foregoing paragraphs have been provided by way of general introduction, and are not intended to limit the scope of the following claims. The various preferred embodiments, together with further advantages, will best understood by reference to the following detailed description taken in conjunction with the accompanying drawings.

### BRIEF DESCRIPTION OF THE DRAWINGS

FIG. 1 is a perspective view of a separating system.

FIG. 2 is an enlarged perspective view of a separating system shown in FIG. 1 taking along line 2.

FIG. 3 is an enlarged perspective of the separating system shown in FIG. 1 taken along line 3.

### DETAILED DESCRIPTION OF THE PRESENTLY PREFERRED EMBODIMENTS

It should be understood that the term “plurality,” as used herein, means two or more. The term “lateral,” as used herein, means situated on, directed toward or running from side to side, and in general, corresponds to the cross-machine direction. The term “freely,” as used herein, means rotatable in either direction in response to an external force. The term “article,” as used herein, means any solid, or other like material, including for example and without limitation, various food stuffs, including for example and without limitation, vegetables (raw and individually quick frozen), meat, poultry, potato products (including for example french fries) and like materials. The term “longitudinal,” as used herein, means of or relating to length or the lengthwise direction and in general corresponds to the machine direction. The term “attached” or “connected” in reference to two or more elements, as used herein, means the elements can be directly or indirectly attached or connected to each other, for example, with one or more intervening elements.

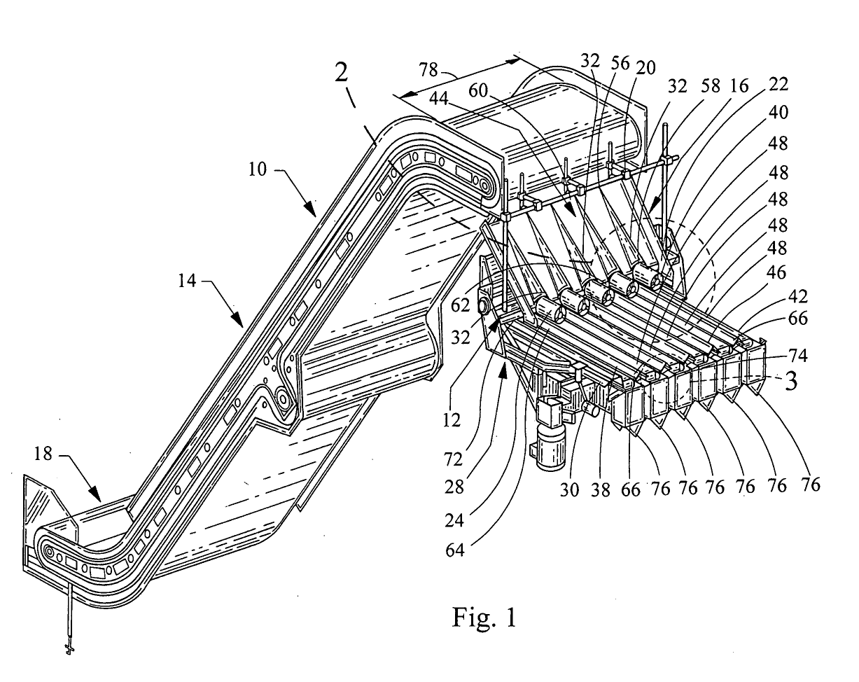

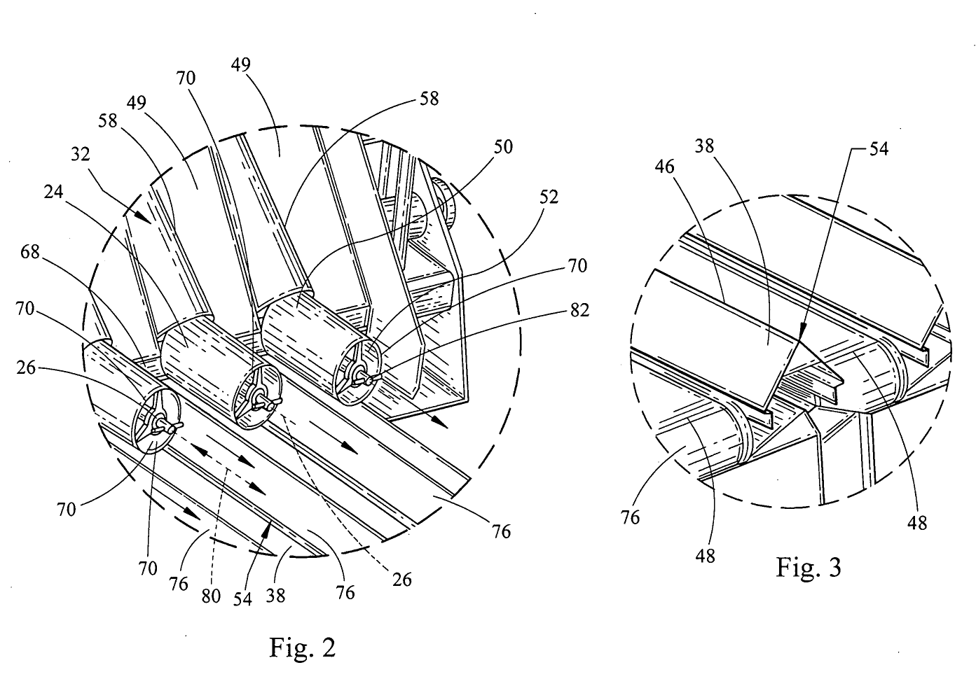

Referring to FIGS. 1 and 2, an infeed device 10 includes a separator system 12 and an incline conveyor 14. In particular, the separator system 12 includes a chute 16 having a first end 20 and a second end 22. The chute 16 is coupled to a receptacle 28 having a first end 72 and second end 74. It should be understood that the chute 16 is angularly adjustable, and can be pivoted relative to the receptacle 28 with any number of actuators, including pneumatic and hydraulic cylinders, screws, etc. The chute 16 pivots about a horizontal axis extending in the lateral direction 78. The chute 16 is generally of rectangular shape and can be made, for example and without limitation, out of metal, e.g., stainless steel and/or aluminum, plastic, composites, etc. or other suitable materials. The chute 16 includes a plurality of elongated dividers 32 each having a first end 56 and a second end 58 spaced along a longitudinal direction. The dividers are spaced apart along the lateral direction 78. In one embodiment of the invention, shown in FIG. 1, at least a portion the divider 32 is conical shaped, meaning at least a portion of the divider is formed as some portion of a cone, but not necessarily an entire cone. For example, in one embodiment, the divider is formed as one half of conical structure cut along its longitudinal axis. The protruding portion of the divider may be configured with other suitable shapes. Preferably, the second end of the divider 58 being wider than the first end of the divider 56.

In one embodiment, shown in FIG. 1, the plurality of dividers 32 define a plurality of passages 44, having a first end 60 and a second end 62, therebetween, with the width of the dividers 32 being inversely proportional to the width of the passages 44. In other embodiments, the divider can have a triangular cross sectional shape, again with the width of the divider tapering from the second end to the first end. The dividers 32 are preferably made out of metal, including for example and without limitation, stainless steel, aluminum, etc. or any type of material with similar properties.

In the embodiment of FIG. 1, the receptacle 28 has a plurality of separators 38 each having a first end 40 and second end 42. Each separator 38 each extend longitudinally within the receptacle 28 such that the first end 72 of the receptacle 28 is disposed proximate the second end 22 of the chute 16. The term “proximate” means the components are adjacent, and may be but are not necessarily in contact or secured to each other.

In one embodiment, shown in FIG. 1, the plurality of separators 38 extend longitudinally in the receptacle 28 such that they define a plurality of channels 48 therebetween, with each of the channels having a first end 64 and second end 66. As shown in FIG. 3, the separators 38 have a protruding portion shaped like two sides of a triangle, with an apex 54 formed along the top thereof. In other embodiments, the separators 38 can have a curved upper surface, or can be quonset-shaped (half of a cylinder cut along its axis of symmetry). The separators are preferably made out of metal, for example stainless steel, aluminum, etc. or any type of material with similar properties.

In one embodiment, the receptacle 28 includes a conveyor belt 76 disposed adjacent to the separators 38. The conveyor belt 76 can be configured as a single belt, extending laterally across the width of the receptacle under the separators 38, or as a plurality of individual belts positioned between the separators, perhaps with portions thereof also disposed beneath the separators. The belt or belts can be driven for example and without limitation, by an electrical motor or a servo.

Referring to FIGS. 1-3, a plurality of rollers 24 are positioned adjacent the second end 22 of the chute 16 at locations spaced apart in the lateral direction 78. The rollers can be coupled to the chute, the receptacle or some other support structure. In one embodiment, shown in FIG. 2, the rollers 24 are freely rotatable about an axis 26 and are removably secured to a support structure 68. The rollers 24 have at least one opening 70 extending therethrough. In one embodiment, as shown in FIG. 2, the rollers 24 are substantially aligned in the longitudinal direction 80 with the dividers 32 and the separators 38, with the understanding that the rollers can be positioned above, or in-line (within the same plane) with, the separators. As shown in FIG. 2, a portion of the receptacle 28, and in particular the conveyor, is located on either side of the roller 24. In one embodiment, the rollers 24 are positioned in front of the first end 40 of the separator 38, or alternatively as shown in FIG. 2, above the first end 40 of the separator 38. The rollers 24 preferably have a diameter that is substantially equal to the width of the second end 58 of the divider 32. In one embodiment, the rollers 24 have a first end 50 disposed under the second end 58 of the dividers 32, with a portion of the roller 24 extending into an opening formed by the divider 32. The rollers 24 are preferably made out of metal, e.g. stainless steel, aluminum, etc. or any other suitable material. The rollers 24 are removably secured to the support structure, for example with an axle, configured for example as a screw 82, such that the rollers may be easily removed for sanitizing or replacement.

In operation, articles are dumped into a hopper 18. The articles are transported by the incline conveyor 14, which deposits articles onto the first end 20 of the chute 16. Because the first end 56 of the divider 32 is narrower than the second end 58 of the divider 32, the articles are directed into separate passages 44 as the articles longitudinally traverse down the chute 16, wherein after they are deposited onto the receptacle, for example the conveyor. On occasion, at the second end 22 of the chute 16, an article such as poultry part, or portions thereof, slides down on top of the dividers 32, rather than within the passages 44, and thereafter impacts one or more rollers 24 under the force of gravity. The roller, which is freely rotatable, rotates to one side or the other in response to the external impact force such that the article falls on either side of the roller 24 into one of the channels 48. The separators 38 restrict the article's lateral movement such that the articles are transported within the channels 48 to another process or system, such as a scale. In operation, the rollers 24 prevent food poultry parts from getting hung up on the separators 38.

In the preferred embodiment, the freely rotatable rollers are free of any restraint and are not restrained in any rotational direction, and will freely rotate clockwise or counterclockwise about the rotational axis depending on the rotational instability of the roller due to the article disposed on top of the roller.

In an alternative embodiment, the rollers 24 are constrained or restrained. In this embodiment, the rollers are configured with a sensor, which senses when an article impacts the roller, and signals an actuator to rotate the roller 24 in one direction or the other. In this embodiment, the actuator, or processor controlling the actuator, can be programmed to rotate the roller in a specific sequence, for example always in the clockwise or counterclockwise direction, alternating between those two directions, or in response to the relative capacity of the adjacent conveyors (e.g, a sensor provides feedback about the capacity of the conveyors and the actuator rotates to deposit the article on the conveyor having a greater capacity).

As shown in FIG. 2, because the rollers 24 are positioned adjacent to the second end 22 of the chute 16, any articles not disposed within the passages 44, will impact the rollers 24 such that the articles will be displaced by the roller into one of the channels 48 of the conveyor 30. As further shown in FIG. 2, by having the chute 16 pivotally attached to the conveyor 30, the angle of the chute is adjustable such that the angle may be modified to alter the rate of article separation. The previously described versions of the present invention have many advantages, including efficiently separating the articles with a roller 24 onto a receptacle 28 for a subsequent process or method.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. An separating system for separating articles, comprising:
a chute comprising first and second longitudinally spaced ends;
at least one roller comprising first and second longitudinally spaced ends, wherein said at least one roller is positioned adjacent to said at least one second end of said chute, said roller being rotatable about an axis; and
at least one receptacle having at least a portion thereof disposed on at least one side of said roller.

2. The separating system of claim 1, wherein said receptacle comprises a conveyor.

3. The separating system of claim 1, wherein said at least one roller comprises a plurality of rollers spaced apart in a lateral direction.

4. The separating system of claim 1, wherein said chute comprises at least one divider having first and second longitudinally spaced ends.

5. The separating system of claim 4, wherein said at least one divider comprises a plurality of dividers defining at least one passage therebetween.

6. The separating system of claim 4, wherein said at least one divider has a greater width at said second end than said first end.

7. The separating system of claim 4, wherein said at least one divider is substantially aligned with said at least one roller along said axis.

8. The separating system of claim 4, wherein said at least one divider has an apex formed along a top thereof.

9. The separating system of claim 4, wherein at least a portion of said at least one divider has a conical shape.

10. The separating system of claim 4, wherein the diameter of said at least one roller is substantially equal to a width of said second end of said at least one divider.

11. The separating system of claim 1, wherein said at least one roller is freely rotatable in clockwise and counterclockwise directions.

12. The separating system of claim 1, wherein said at least one roller has at least one opening extending therethrough between said first and second ends.

13. The separating system of claim 1, wherein said at least one roller is removably secured to a support structure.

14. The separating system of claim 1, wherein said receptacle comprises at least one separator having first and second longitudinally spaced ends.

15. The separating system of claim 14, wherein said at least one separator comprises a plurality of separators defining at least one channel therebetween.

16. The separating system of claim 14, wherein said at least one separator is substantially aligned with said at least one roller along said axis.

17. The separating system of claim 14, wherein said second end of said at least one roller is adjacent to first end of said at least one separator.

18. The separating system of claim 14, wherein said at least one separator has an apex formed along a top thereof.

19. The separating system of claim 14, wherein at least a portion of said at least one separator has a conical shape.

20. The separating system of claim 1, wherein said chute is angularly adjustable relative to a horizontal plane.

21. The separating system of claim 1, wherein said at least one roller comprises a stainless steel material.

22. A method for separating articles, comprising the steps of:
moving said articles along a chute having first and second ends;
impacting a roller positioned adjacent to said second end of chute with at least one of said articles; and
rotating said roller and thereby displacing said at least one of said articles to one side of said roller.

23. The method as recited in claim 22, further comprising altering a slope of said chute.

24. The method as recited in claim 22, wherein said displacing said at least one article comprises transferring said at least one article to a receptacle.

25. The method as recited in claim 24, wherein said receptacle is a conveyor.

26. The method as recited in claim 25, further comprising transporting said at least one article with said conveyor to an accumulator.

27. The method as recited in claim 22, wherein said articles are food products.

28. A separating system for separating articles comprising:
a chute comprising first and second longitudinally spaced ends;
a plurality of laterally spaced rollers positioned adjacent to said second end of said chute, said plurality of rollers each being rotatable about an axis;
at least one receptacle having at least a portion thereof disposed on at least one side of at least one of said plurality of rollers;
a plurality of separators defining at least one channel therebetween and each having first and second longitudinally spaced ends.

29. The separating system of claim 28, wherein said chute comprises a plurality of dividers defining at least one passage therebetween.

30. The separating system of claim 28, wherein said plurality of rollers are freely rotatable in clockwise and counterclockwise directions.

31. The separating system of claim 28, wherein said receptacle has a plurality of longitudinally extending separators substantially aligned with said plurality of rollers.

32. The separating system of claim 29, wherein said plurality of dividers is substantially aligned with said plurality of rollers.
